(19) United States
(12) Patent Application Publication
(10) Pub. No.: US 2004/0138870 A1
(43) Pub. Date: Jul. 15, 2004

(54) Method and system for efficient character-based processing

(76) Inventor: Chung Chan, Harbour City (CN)

Correspondence Address: KEVIN A. BUFORD, HOLLAND & KNIGHT LLP, 1600 TYSONS BOULEVARD, SUITE 700, MCLEAN, VA, 22102, US

(21) Appl. No.: 10/698,935

(22) Filed: Nov. 3, 2003

Related U.S. Application Data
(60) Provisional application No. 60/423,258, filed on Nov. 1, 2002.

(51) Int. Cl. G06F 17/28

(52) U.S. Cl. 704/2

(57) ABSTRACT

An illustrative summary of the invention, with particular reference to the detailed embodiment described below, includes a method and apparatus for processing character-based languages in a mobile system. This includes a central mobile processor capable of very long instruction word (VLIW) processing and efficient non-romance language character generation. This is preferably integrated with the DSP (digital signal processor) used for applications such as converting analog speech to/from a digital representation. A compression engine may also be included as part of the the mobile unit and corresponding network routers. This allows one to design a flexible, low-power processor for the next-generation mobile devices.

### FIELD OF THE INVENTION

The invention in general relates to the field of wireless communications, and more particularly to mobile processor systems for efficient character rendering and generating.

### BACKGROUND

China is the world's largest mobile market by subscriber base and will be the market generating the world's highest handset demand within the next couples of years. In addition, China is expected to be the world's largest center of mobile handset production accounting for approximately 34% of world's production by the year of 2004.

With the introduction of 2.5 G and 3 G mobile networks, the users can enjoy a bandwidth up to 2 Mbps on their mobile handset. This opens up the opportunity for a whole new set of applications on mobile handset. The next generation mobile handsets will have vivid color display and will be able to deliver video and audio contents as well as running Java applications.

The manufacturers in China are taking two routes to develop their mobile phones. First, many China-based handset OEMs are quietly sourcing their products from companies in Taiwan, such as Arima, Acer, GVC, Inventec and others. At the same time, they are also developing their own products. But because they have little or no expertise in handset design, domestic OEMs are forging key alliances with foreign chip makers.

GSM have been a very successful mobile network standard which is operating in all five continents and connected to more than 600 millions subscribers. With the increasing demand in wireless data applications, 2.5 G standard named GPRS (General Packet Radio Service) and CDMA 2000 1X are now being deployed by operators. Both GPRS and CDMA allow the efficient use of the air interface by packet-oriented data transfer. It can provide a bandwidth up to 100 kbps, depending on cell load and interference level. To provide even more bandwidth and cell capacity, the Third Generation (3G) system will be deployed in the coming years. The major technologies families are UMTS/EDGE and CDMA2000. It is forecasted that UMTS will represent more than 90% of the 3G markets. With the 3G systems it is expected that the users can experience a data rate from 384 kbps up to as high as 2 Mbps.

The next generation mobile network can provide more and more bandwidth to the handsets. In addition, new technologies allow larger and more vivid color LCD display to be put on the handsets. These improvements in turn enable a whole new set of applications to be put on the mobile phones. These handsets are expected to provide rich voice and video contents in applications like Multimedia Messaging Service (MMS), Java applications, Email with voice and video attachments, and video conferencing. In addition, many of the applications will be delivered to the users by Over The Air (OTA) download. Therefore the next generation handsets should have the capabilities to handle performance-intensive applications like MPEG-4 video, speech and handwriting recognition and Java interpretation.

However, a key problem with existing wireless architectures is their reliance on english and ASCI-based designs. The internal processing languages is based on english-based coding at the processor level, not natural languages for character-based languages like Chinese, Japanese and Arabic. To accomplish even simple display of one of these languages typically requires translation to/from the different native processor language. Using ARM processor cores, such as is found in most cell phones, further limits a robust deployment of natural language processing in view of the lower computational power available.

What is needed is a processor system that is designed to more efficiently accommodate character-based languages, in low power and high computational performance core, for wireless systems. Just such a solution to the problems noted above and more, are made possible by my invention disclosed here.

### SUMMARY

An illustrative summary of the invention, with particular reference to the detailed embodiment described below, includes a method and apparatus for processing character-based languages in a mobile system. This includes a central mobile processor capable of very long instruction word (VLIW) processing and efficient non-romance language character generation. This is preferably integrated with the DSP (digital signal processor) used for applications such as converting analog speech to/from a digital representation. A compression engine may also be included as part of the the mobile unit and corresponding network routers. This allows one to design a flexible, low-power processor for the next-generation mobile devices.

### THE FIGURES

My invention may be more readily appreciated from the following detailed description, when read in conjunction with the accompanying drawings, in which:

FIG. 1 is a block diagram of a character-based language processor according to a first embodiment of the invention;

FIG. 2 is a block diagram of a natural language enabled communications unit, including the processor of FIG. 1, according to a first embodiment of the invention;

FIG. 3 illustrates the different software layers used according to the first embodiment of the invention;

FIG. 4 is a network diagram illustrating data flow using the first embodiment of the invention;

FIG. 5 is a block diagram of a routing engine according to a further embodiment of the invention; and

FIG. 6 illustrates the different software layers used according to the further embodiment of the invention.

### DETAILED DESCRIPTION OF AN EMBODIMENT OF THE INVENTION

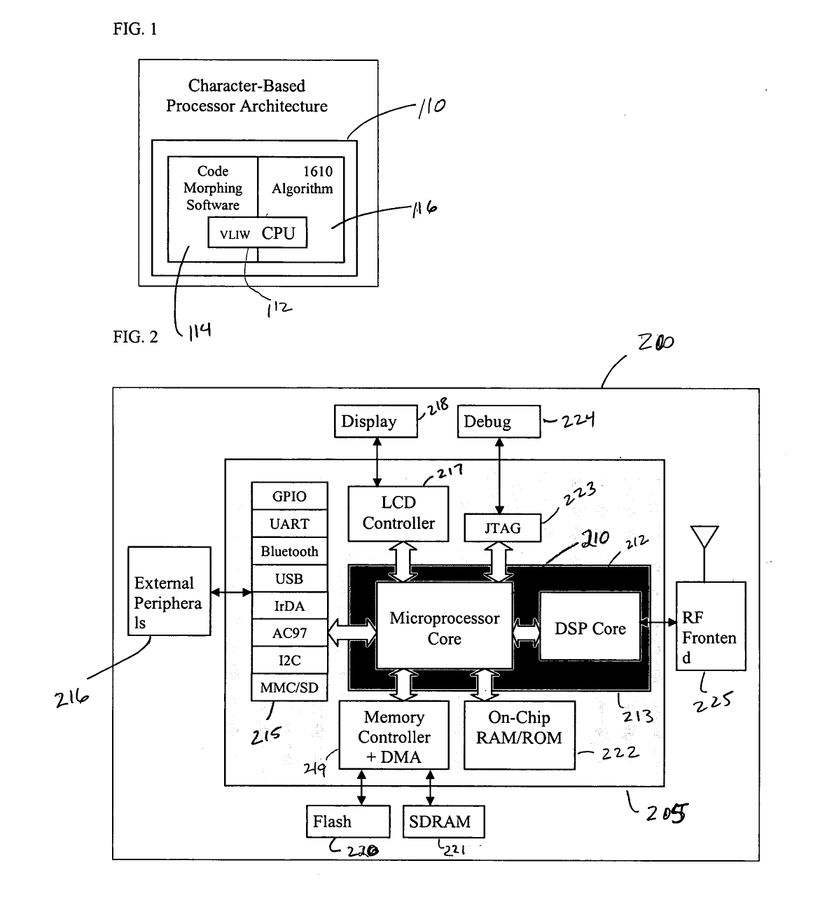

Turning now to FIG. 1, a processor core 110 according to a first embodiment of the invention can be of the type such as Crusoe from Transmeta, and more generally is a VLIW processor. If x86 processor compatibility is desired, Code Morphing software, residing on a flash ROM on the processor, may be introduced to translate x86 instruction codes to VLIW instructions. The Code Morphing software may also performs code optimization and power management on the VLIW CPU to ensure optimal performance.

For character-based generation (by which we mean characters of character-based natural languages, which excludes the romance languages like english, but specifically includes languages like Chinese, Japanese, Russian and Arabic), a ROM IC provided by Culturecom 1610 can be used. Its Chinese technology is specially designed for low power, low memory requirement devices like cell phones, ebooks and PDAs. With its unique encoding algorithm, it can store more than 30000 scale Chinese characters with only 150 KB of memory. Even for a font set of more than 100,000 characters, it occupies only 260 KB of memory.

The processor core is designed to combine both the advantage of a VLIW CPU 112 with Code Morphing Software 114 that integrates efficiently the character algorithm 116 that computes the large set of character-based language characters (For simplification of discussion, it should be understood that the discussion about Chinese language below encompasses all character-based natural languages). Using the Low Power Processor Architecture, the Chinese fonts library could be fit into the on-chip flash ROM easily due to its extremely compact nature. To achieve highest efficiency while maintaining power consumption to the lowest level, the Chinese font rendering and processing algorithm is preferably ported to native VLIW instructions and run directly on the VLIW core. The Chinese algorithm is run along side with the Code Morphing software and provides Chinese support by either as system services of the processor or as a special extension of the processor instructions set.

Turning now to FIG. 2, a higher level of integration can be provided on the handset processor 210 by integrating a Digital Signal Processor (DSP) core 212 is on the chip 205. A DSP is faster and more power efficient in handle computational intensive tasks. Therefore adding a separate DSP core not only offloads the main processor core, and is also able to maintain a low power consumption. The DSP core is preferably used to handle computational intensive tasks like speech coding, channel coding and equalization as well as some complementary features like echo/noise suppression, speech recognition and data compression. The rest of the tasks on the handset will mostly hand back to the processor core 210. The processor core 210 will be responsible for driving the man-machine interface (MMI) software, GSM protocol stacks, peripheral interfaces (like USB and Bluetooth), power management and user applications like Web, email, instant messaging, and the like.

To keep the design of handset simple and to keep of number of chip count to a minimum, the chip 205 has a rich set of peripheral controllers built-in. These include:

Display (e.g., LCD) Controller 217—supports displays, including gray-scale and color LCD modules, and support of 2/4/8/12/16-bit per pixel display up to a resolution of 1024×1024 (and higher in future generation devices).

Memory/DMA Controller 219—supports direct connection to 64 MB of addressable SDRAM 221 up to 100 MHz and to 32 MB of addressable Flash 220 (asynchronous or burst).

RF Front-end Interface 225—provide an interface to the RF front-end.

JTAG Port 223—provide a standard interface for in-circuit emulation and debugging 224.

Other controllers 215 coupled to external peripherals 216:

GPIO—a set of programmable General Purpose I/O pins for controlling and interfacing other additional components

UART—provide two standard UART interfaces that are controllable through a software interface or hardware flow control signals.

Bluetooth—provide a high-speed UART and MCSI serial port that allows developers to easily incorporate the Bluetooth feature.

USB—a universal serial bus (USB) client controller for high-speed plug-and play synchronization with computer or master device. The chip has also a USB host controller, with up to three down stream ports. Both the host and client controllers are compliant with the USB specification version 1.2.

IrDA—provide infrared data adapter (IrDA) 1.0 serial infrared (SIR) support for serial communication up to 115.2 kbps.

Keypad—an interface to handset keypad.

I2C—an I2C host port complaint with Philips I2C standard. The interface is a single master only, half-duplex serial port using two lines (data and clock) for data transmit with software addressable external devices.

MMC/SD—allows connections of industry standard (Secure Digital/MultiMedia Card Controller) flash storage cards in I/O peripheral mode. The interface is compliant with MMC standard specification version 2.2 and the SD Physical Layer specification version 1.0.

SIM—supports 3-5V Subscriber Information Module (SIM) interface complaint to ETSI-GSM standard.

While some of the above controllers and peripherals have been described in terms of current performance specifications (speed, etc.), one skilled in the art will readily appreciate how the invention is not so limited, and that future wireless devices may have higher performance based on then current technologies and system design choices.

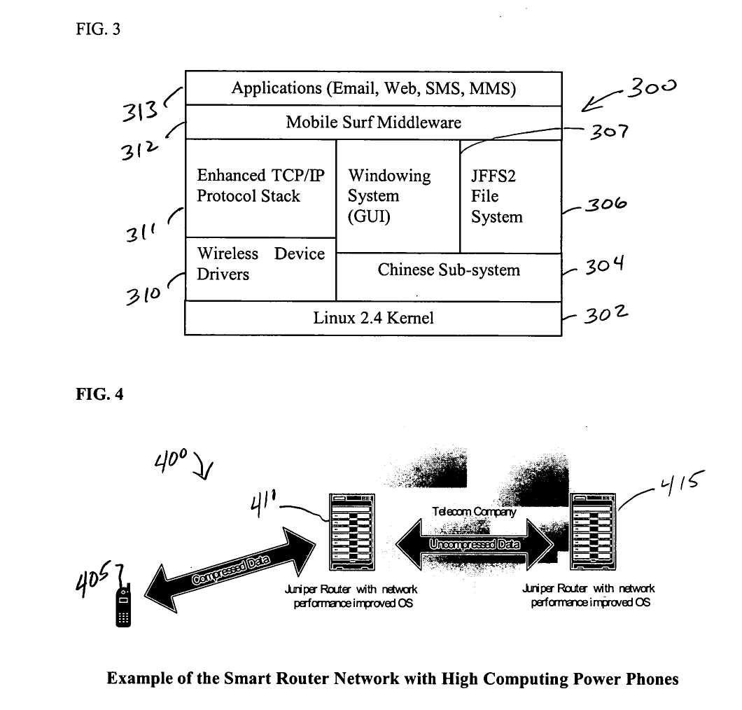

FIG. 3 illustrates the software that may be advantageously used in a mobile system according to the invention. To provide a complete Chinese-character mobile computing environment, a robust operating system 302 such as a Linux operating system leveraging both the mobile computing set such as Transmeta's Midori Linux and a Chinese operating system 304 such as the Chinese 2000 Linux. The operating system preferably adopts power management features to fully utilize the CPU computing power. To optimize the performance on Chinese processing, a special Linux driver 310 is used to interface with the Chinese algorithm on the processor. The system preferably has a full Chinese GUI 307, Chinese input method, Chinese hand writing recognition and a complete set of Chinese mobile data applications 313. Also included is an enhanced TCP/IP protocol stack 311, JFFS2 File system, and mobile middleware 312.

While having more and more applications on the mobile phone, the user expectation on the power consumption and form factor remain the same. They would still like a have a compact mobile phone to carry around which can operate a few days with a single recharge. For mobile phone users, the new products will mean longer battery life, less wait time for data access and higher throughput of data. While increasing the processing power to handle computation intensive tasks, there is a challenge for the engineers to keep the power consumption low and the size of the mobile phone small.

One very effective approach to tackle this problem is try to put as many components as possible on the processor chip. This is usually referred as System On Chip or SoC. The idea is to maximize computing power and storage while minimizing the size of the processor for wireless devices. With high level of integration, the design of the mobile phone can be simplified; the total number of component as well as cost can be reduced. In addition, the overall power consumption can be reduced and therefore the battery life can be extended.

With the current technology, we could build both the processor core and the DSP core on a single chip. The next step will be to integrate a DSP core to the chip to provide the chip with the baseband as well as signal processing functionality. To further reduce the chip-count and the form factor of our solution, one preferably will also integrate the flash memory onto the chip. A final goal could be to integrate all the analog and digital parts onto a single chip, so that the software, baseband technology, applications processing, power management, radio frequency and embedded memory are combined into a single chip.

Turning now to FIG. 4, an example is shown of a smart router network with high computing power character-based wireless phones. A Compression Engine is a high performance software encoder for wireless devices, which deals with large amount of data. Highly efficient compression engines can improve both production process and performance of commonly used content that are offered in Wireless LAN, GSM, GPRS and fixed network.

Routers and high-end networking products could be designed to take full advantages of the invention discussed in connection with the embodiment of FIGS. 1-3. The wireless network market is growing at high rate. Cellular phone penetration is still not high in some countries such as China. However, transmitting data over wireless network raises many technical problems. The problems include high bit error rate, fluctuated delay, packet loss due to handoffs and packet reordering. The first embodiment of the invention discusses an application/baseband processor for next-generation mobile phones 405. This design has the capability to integrate a data compression module into the phone. By adding a data compression module into corresponding routers 410, the traffic volume transmitted over wireless network is reduced. In order to improve network performance of routers and network components in general, one will also modify the protocol stack and network layer implementations such as FreeBSD and JUNOS (commonly used in Juniper Networks' router products).

Some of the benefits of applying compression and acceleration technology on routers include:

Reduces packet traffic on a link.

Allows more data to be transmitted using the same amount of bandwidth and reducing the need for costly additional WAN links or circuits.

Enables customer to deploy additional services without increasing bandwidth.

Improves application response time on congested links and slow links.

Helps Juniper to penetrate mobile network backbone market.

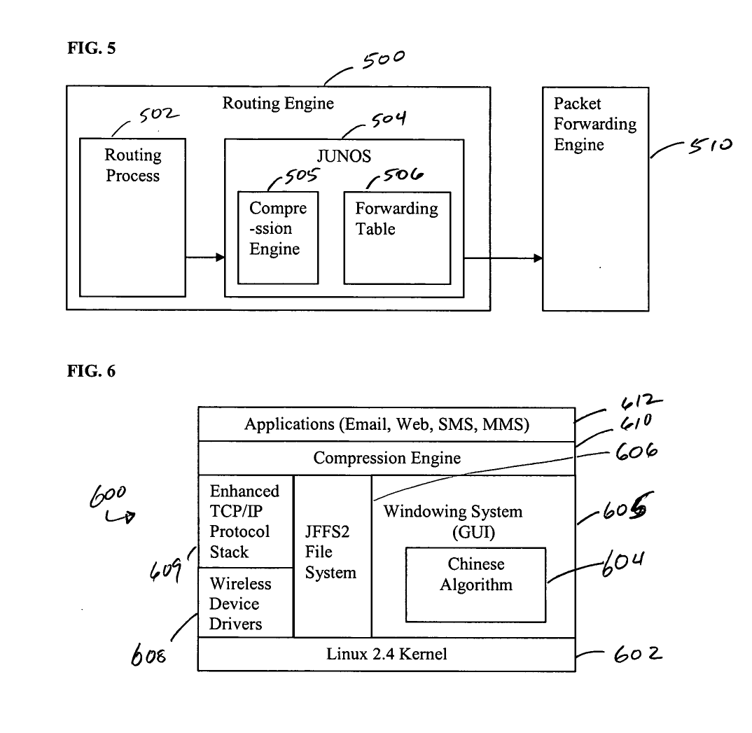

For example, one will modify the protocol stack and network layer implementation under presentation layer of a system like the FreeBSD operating system. The modification to the protocol stack will improve the network performance between routers. One also may add a compression engine to the operating system. The compression engine will improve the network performance router and mobile phone. The data traffic across wireless network is compressed. The decompression will be performed by the aforementioned mobile phone processor and/or the Chinese Character engine. Similarly, one can introduce the capability to include the compressor on the mobile phone. The compression coding can be modified and tuned for different OSs such as Unix and Windows platforms. The platform may also include FreeBSD, which is the origin of JUNOS. Thus, in a further embodiment as is illustrated in FIG. 5, when the route of the traffic is determined by route processer 502, the packets are processed by the acceleration engine 505, built in the JUNOS 504 before they are sent to the Forwarding Table 506. These are then forwarded from the routing engine 500 via packet forwarding engine 510.

The followings are the items that may be included in the OS (such as FreeBSD):

Application Layer Data Compression: The compression engine dramatically improves both the production process and the performance of content download. The performance may be up to six times faster than download without compression today.

Robust Header Compression Scheme (ROHC): Existing IP header compression scheme do not work well on noisy links, especially for those with high bit error rate and long delay. But an error on a single segment could make the whole window unusable. In addition, these schemes have not addressed how to compression TCP options like SACK and Timestamps. An ROHC may be used to specifically address these issues.

Selective Acknowledgment: Selective Acknowledgment is an effective scheme when multiple TCP segments are lost in a single TCP window. It allows the receiver notify the sender explicitly the missing segments and minimize unnecessary retransmissions.

Extension of SACK: It specifies the use of the SACK option when duplicated segments are received. This extension to the SACK option allows the TCP sender to infer the order of packets received at the receiver, allowing the sender to infer when it has unnecessary retransmitted a packet. A TCP sender could then use this information for more robust operation in an environment of reordered packets, ACK loss, packet replication and/or early retransmit timeouts.

Explicit Congestion Notification: Explicit Congestion Notification allows a TCP receiver to inform the sender of congestion in the network by setting the ECN-Echo flag upon receiving an IP packet marked with the CE bits. The TCP sender will then reduce its congestion window. But it can only be achieved if ECN capable routers are deployed along the path.

Eifel Algorithm: Eifel Algorithm uses the TCP Timestamps option to remove retransmission ambiguity and reduce spurious retransmission.

With the aforementioned an application/baseband processor for next-generation mobile phones and the introduction of 2.5 G and 3 G mobile networks, multimedia and interactive applications may be delivered on new mobile phones. The processor is designed to handle these emerging applications. The processor is able to handle computational intensive tasks while maintaining a low power consumption and small form factor. On top of this processor, an operating system is also presented that can provide a complete mobile handset solution for the manufacturers. Further shown is a compression engine can be built in the core of the operating system to provide the highest efficiency and seamless connection to the compression engine on routers, soft switch, media controller and similar network components. Thus, all the compressed data received through the wireless network may be decompressed in the operating system first before presenting to the applications on the mobile phone. This approach effectively minimized the overhead of the compression engine and also makes the compression transparent to the mobile phone application developers.

FIG. 6 illustrates the architecture of mobile phone components that could match an intelligent network component, including using Chinese Linux as a efficient and low cost base operating system. This includes the GUI and Chinese algorithm 604-605, operating on top of the OS (Linux) 602, together with device drivers 608, protocol stack 609, and file system 606. A compression engine 610 efficiently compresses the character-based data, for use by various applications 612.

Of course, one skilled in the art will appreciate how a variety of alternatives are possible for the individual elements, and their arrangement, described above, while still falling within the spirit of my invention. Thus, for example, while the invention has been described in connection with the Chinese language and Chinese processers/algorithm, it is equally applicable to the other character-based languages, that need far greater computational power on wireless devices than do applications written around the English language. Thus, it is to be understood that the invention is not limited to the embodiments described above, and that in light of the present disclosure, various other embodiments should be apparent to persons skilled in the art. Accordingly, it is intended that the invention not be limited to the specific illustrative embodiments but be interpreted within the full spirit and scope of the appended claims.

I claim:

1. An mobile communications device for use with character-based languages, comprising:
a character-based VLIW (very long instruction word) processor which comprises a VLIW processor core and a character algorithm operable for determining a set of character-based language (CBL) characters.

2. The device of claim 1, further comprising code morphing software operable for translating x86 instructions to VLIW instructions, wherein the character algorithm is a native VLIW algorithm.

3. The device of claim 2, wherein the processor is part of a system on a chip which further comprises a DSP (digital signal processor) core operable for speech and channel coding, speech recognition and data compression.

4. The device of claim 3, the system on a chip further comprising display, memory and peripheral controllers.

5. The device of claim 2, wherein the processor is part of an integrated circuit which further comprises a DSP (digital signal processor) core operable for speech and channel coding, speech recognition and data compression.

6. The device of claim 2, further comprising instructions operable with the processor for providing a CBL graphical user interface.

7. The device of claim 2, wherein the instructions part of a Chinese language operating system, and the CBL is Chinese language.

8. A system including the device according to claim 5, further comprising a network router with a compression engine, wherein the device and the router are operable to communicate compressed CBL data to each other.

9. The system of claim 8, wherein the router is part of a network of the group of a wireless local area network (LAN), cellular voice, cellular data, and fixed network.

10. A character-based processor for use with character-based languages, comprising:
a VLIW (very long instruction word) processor core; and
a character algorithm operable for determining a set of character-based language (CBL) characters.

11. The processor of claim 10, further comprising code morphing software operable for translating x86 instructions to VLIW instructions.

12. The processor of claim 10, wherein the character algorithm is a native VLIW algorithm.

13. A system on a chip including the processor of claim 10, wherein the system on a chip further comprises a DSP (digital signal processor) core operable for speech and channel coding, speech recognition and data compression.

14. The system of claim 13 further comprising display, memory and peripheral controllers.

15. The processor of claim 10, wherein the processor is part of an integrated circuit which further comprises a DSP (digital signal processor) core operable for speech and channel coding, speech recognition and data compression.

16. The processor of claim 15, further comprising instructions operable with the processor for providing a CBL graphical user interface.

17. The processor of claim 16, wherein the instructions part of a Chinese language operating system, and the CBL is Chinese language.

18. A system including plural wireless communication devices, each device comprising a processor according to claim 17, the system further comprising a network router with a compression engine, wherein the device and the router are operable to communicate compressed CBL data to each other.

19. The system of claim 18, wherein the router is part of a network of the group of a wireless local area network (LAN), cellular voice, cellular data, and fixed network.

20. A method for processing data for communicating a character based language (CBL), comprising:
processing CBL characters in a character-based VLIW (very long instruction word) processor which comprises a VLIW processor core and a native VLIW character algorithm operable for determining a set of character-based language (CBL) characters.
